(19) United States
(12) Patent Application Publication
(10) Pub. No.: US 2026/0041023 A1
(43) Pub. Date: Feb. 12, 2026

(54) TERRAIN-AWARE AUTO-GUIDANCE CONTROL

(71) Applicant: CNH Industrial America LLC, New Holland, PA (US)

(72) Inventors: Abhinav Tripathi, New Holland, PA (US); Aditya Singh, Bolingbrook, IL (US); Heather Paxinos, New Holland, PA (US)

(73) Assignee: CNH Industrial America LLC, New Holland, PA (US)

(21) Appl. No.: 18/798,423

(22) Filed: Aug. 8, 2024

(51) Int. Cl. A01B 69/04; G01S 19/13

(52) U.S. Cl. CPC A01B 69/008; G01S 19/13

(57) ABSTRACT

Systems and apparatuses include a controller for generating a navigational vector for automatically operating a work vehicle along a guidance trajectory; receiving positional data associated with a positional state of the work vehicle; estimating a ground position of an approaching divagation condition in the guidance trajectory of the work vehicle based on the positional data; and adjusting one or more operating parameters of the work vehicle prior to arriving at the ground position to compensate for the approaching divagation condition.

### BACKGROUND

The present disclosure relates to navigational guidance of a work vehicle. More specifically, the present disclosure relates to predictive navigational guidance based on positional data of the work vehicle.

The main idea of the invention is to measure a positional state of a tractor that is automatically traveling down a guided path, and when the positional state corresponds to a future divergence from the guided path (for example, slipping down a hill) automatically adjusting the steering to compensate for the predicted slip

### SUMMARY

In some aspects, the techniques described herein relate to a computer-implemented method including: generating, by a controller, a navigational vector for automatically operating a work vehicle along a guidance trajectory; receiving, by the controller, positional data associated with a positional state of the work vehicle; estimating, by the controller, a ground position of an approaching divagation condition in the guidance trajectory of the work vehicle based on the positional data; and adjusting, by the controller, one or more operating parameters of the work vehicle prior to arriving at the ground position to compensate for the approaching divagation condition.

In some aspects, the techniques described herein relate to a computer-implemented method, further including: receiving, by the controller, geospatial data from a Global Navigational Satellite System (GNSS) receiver communicatively coupled to the controller, wherein the navigational vector is based, in part, on the geospatial data.

In some aspects, the techniques described herein relate to a computer-implemented method, further including: receiving, by the controller, crop data from a crop sensor communicatively coupled to the controller, wherein the navigational vector is based, in part, on the crop data.

In some aspects, the techniques described herein relate to a computer-implemented method, further including: receiving, by the controller, geospatial data from a Global Navigational Satellite System (GNSS) receiver communicatively coupled to the controller; and receiving, by the controller, crop data from a crop sensor communicatively coupled to the controller, wherein the navigational vector is based, in part, on the geospatial data and, when crop data is available, the crop data.

In some aspects, the techniques described herein relate to a computer-implemented method, wherein the positional data includes at least one of a roll amount, a pitch amount, a yaw amount, a rate of change of roll, a rate of change of pitch, and a rate of change of yaw.

In some aspects, the techniques described herein relate to a computer-implemented method, further including: receiving, by the controller, a plurality of incoming positional data of the work vehicle over a period of time; filtering, by the controller, the plurality of incoming positional data of the work vehicle over the period of time; and estimating, by the controller, the positional state of the work vehicle based on the filtered plurality of incoming positional data over the period of time.

In some aspects, the techniques described herein relate to a computer-implemented method, wherein the approaching divagation condition includes a slip condition in which the work vehicle performs an unguided positional adjustment over terrain.

In some aspects, the techniques described herein relate to a computer-implemented method wherein the controller nominally operates the work vehicle in a default positional state, in which the default positional state is a level positional state.

In some aspects, the techniques described herein relate to a computer-implemented method, further including: generating, by the controller, an updated guidance trajectory based on an adjustment of the one or more operating parameters.

In some aspects, the techniques described herein relate to a computer-implemented method, further including: generating, by the controller, an updated guidance trajectory based on an adjustment of a steering angle of a tractive element of the work vehicle, wherein the updated guidance trajectory compensates for an increased width of an area crossed by the tractive element of the work vehicle during the adjustment of the steering angle of the tractive element of the work vehicle.

In some aspects, the techniques described herein relate to a computer-implemented method, wherein the one or more operating parameters is a steering angle.

In some aspects, the techniques described herein relate to a computer-implemented method, wherein the approaching divagation condition is one of a hill, a furrow, an incline, a ditch, an area of reduced traction, and an area of increased traction.

In some aspects, the techniques described herein relate to a computer-implemented method, wherein the controller adjusts the one or more operating parameters to compensate for the approaching divagation condition such that an implement coupled to the work vehicle maintains the guidance trajectory.

In some aspects, the techniques described herein relate to a computer-implemented method, wherein the controller adjusts the one or more operating parameters to compensate for the approaching divagation condition such that the work vehicle maintains the guidance trajectory.

In some aspects, the techniques described herein relate to a computer-implemented method, wherein the work vehicle is one of a tractor, a combine, and a speedrower.

In some aspects, the techniques described herein relate to a system including, a work vehicle; a positional sensor; and a controller, the controller including one or more processors including one or more memory devices coupled to the one or more processors, the one or more memory devices configured to store instructions thereon that, when executed by the one or more processors, cause the one or more processors to: receive a navigational vector for automatically operating a work vehicle along a guidance trajectory; receive positional data associated with a positional state of the work vehicle; estimate a ground position of an approaching divagation condition in the guidance trajectory of the work vehicle based on the positional data; and adjust one or more operating parameters of the work vehicle prior to arriving at the ground position to compensate for the approaching divagation condition.

In some aspects, the techniques described herein relate to a system, wherein the one or more memory devices are configured to store further instructions thereon that, when executed by the one or more processors, cause the one or more processors to: receive a plurality of incoming positional data of the work vehicle over a period of time; filter the plurality of incoming positional data of the work vehicle over the period of time; and estimate the positional state of the work vehicle based on the filtered plurality of incoming positional data over the period of time.

In some aspects, the techniques described herein relate to a system, wherein the one or more memory devices are configured to store further instructions thereon that, when executed by the one or more processors, cause the one or more processors to: generate an updated guidance trajectory based on an adjustment of the one or more operating parameters.

In some aspects, the techniques described herein relate to a work vehicle including, a frame; a front tractive assembly coupled to the frame, the front tractive assembly including a front axle; a rear tractive assembly coupled to the frame, the rear tractive assembly including a rear axle; a prime mover coupled to the frame and configured to drive one or more of the front tractive assembly and the rear tractive assembly to propel the work vehicle; and a controller, the controller including one or more processors including one or more memory devices coupled to the one or more processors, the one or more memory devices configured to store instructions thereon that, when executed by the one or more processors, cause the one or more processors to: receive a navigational vector for automatically operating a work vehicle along a guidance trajectory; receive positional data associated with a positional state of the work vehicle; estimate a ground position of an approaching divagation condition in the guidance trajectory of the work vehicle based on the positional data; and adjust one or more operating parameters of the work vehicle prior to arriving at the ground position to compensate for the approaching divagation condition.

In some aspects, the techniques described herein relate to a work vehicle, wherein the one or more memory devices are configured to store further instructions thereon that, when executed by the one or more processors, cause the one or more processors to: receive a plurality of incoming positional data of the work vehicle over a period of time; filter the plurality of incoming positional data of the work vehicle over the period of time; and estimate the positional state of the work vehicle based on the filtered plurality of incoming positional data over the period of time.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a driveline of the vehicle of FIG. 1, according to an exemplary embodiment.

FIG. 4 is a schematic block diagram of sensors, a controller, and various subsystems of the vehicle of FIG. 1, according to an exemplary embodiment.

FIG. 5 is a front view of a vehicle traversing an anomalous terrain condition, according to an exemplary embodiment.

FIG. 6 is a top view of a vehicle traversing an anomalous terrain condition, according to an exemplary embodiment.

FIG. 7 is a top view of a vehicle traversing an anomalous terrain condition, according to an exemplary embodiment.

FIG. 8 is a flowchart of a computer-implemented method for preemptively adjusting operating parameters of a vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Automatic navigation of agricultural machinery has emerged in an effort to increase efficiency to meet increasing demands of the world's agricultural sector. This emergence of automatic navigation of agricultural machinery has indeed resulted in increased efficiency for many farmers. However, shortcomings and difficulties still remain with regard to traditional methods and systems for automatically navigating agricultural vehicles still. By way of example, the topography of a farm where a combine harvester operates significantly influences the effectiveness of the auto-guidance system. Given that combines encounter diverse terrains across different farms, the guidance controller must be initially calibrated for typical terrain conditions and then thoroughly tested across various terrains to ensure robustness and stability. However, this process is resource-intensive and time-consuming. It involves sacrificing some level of performance to prioritize robustness, leading to sub-optimal outcomes. In other words, navigational guidance systems may be calibrated to work ideally in one environment, or alternatively, calibrated to work sub-optimally in multiple environments.

The present disclosure contemplates various solutions to the above-mentioned shortcomings of traditional guidance systems for a vehicle used in agricultural settings. In one embodiment, a controller onboard the vehicle is calibrated to function at peak performance in ideal conditions (e.g., flat, dry, hard terrain with no obstacles). These ideal conditions may be considered a nominal condition. The nominal condition provides default parameters for determining which adjustments to make to one or more operating parameters of the vehicle to operate along a predetermined or dynamically determined guidance trajectory. Peak performance may include a maximally efficient operation. During automatic navigation of the vehicle along the guidance trajectory, the controller, by default, operates one or more operating parameters of the vehicle based on the nominal condition to maintain operation of the vehicle along the guidance trajectory. However, to increase overall efficiency, the controller may be further calibrated to adjust functionality due to suboptimal conditions (e.g., sloping, wet terrain with obstacles. A suboptimal condition that varies from the nominal condition may be considered an anomalous condition. Various anomalous conditions may exist, including terrain with decreased traction and/or increased traction, sloping terrain, varying ground material, and undulations in the terrain. In some embodiments, the controller is calibrated to predict upcoming anomalous conditions and adjust operation to compensate for the anomalous conditions, thereby maintaining peak performance across a wide range of environments and conditions (e.g., both nominal and anomalous conditions).

According to at least one embodiment of the current disclosures, the controller predicts anomalous conditions based on a predetermined guidance trajectory in conjunction with a determined positional state of the vehicle. Positional states may include level, pitch, roll, yaw, etc. The controller may be in communication with one or more positional sensors that receive positional data corresponding to one or more positional states of the vehicle (e.g., roll pitch data, roll data, yaw data). The one or more sensors may then transmit (or otherwise communicate) the received positional to the controller.

Upon receiving the transmitted positional data, the controller, through one or more systems and modules, may determine a current positional state of the vehicle (e.g., pitched, rolled, yawed) and predict current and future anomalous conditions. Responsive to predicting a current and/or future anomalous condition, the controller predicts whether the current and/or future anomalous condition is a divagation condition (e.g., a set of conditions that may result in the vehicle performing an unguided positional adjustment, such as a hill, a furrow, an incline, a ditch, an area of reduced traction, and/or an area of increased traction). Responsive to determining that the vehicle is in, or will be in, a divagation condition, the controller adjusts the operation of the vehicle to compensate for the predicted divagation condition. In some embodiments, the controller may store various operating protocols that may be executed in response to varying conditions and environments. By way of example, the controller may execute a nominal protocol, a slide protocol, a slip protocol, a hill protocol, etc.

### Overall Vehicle

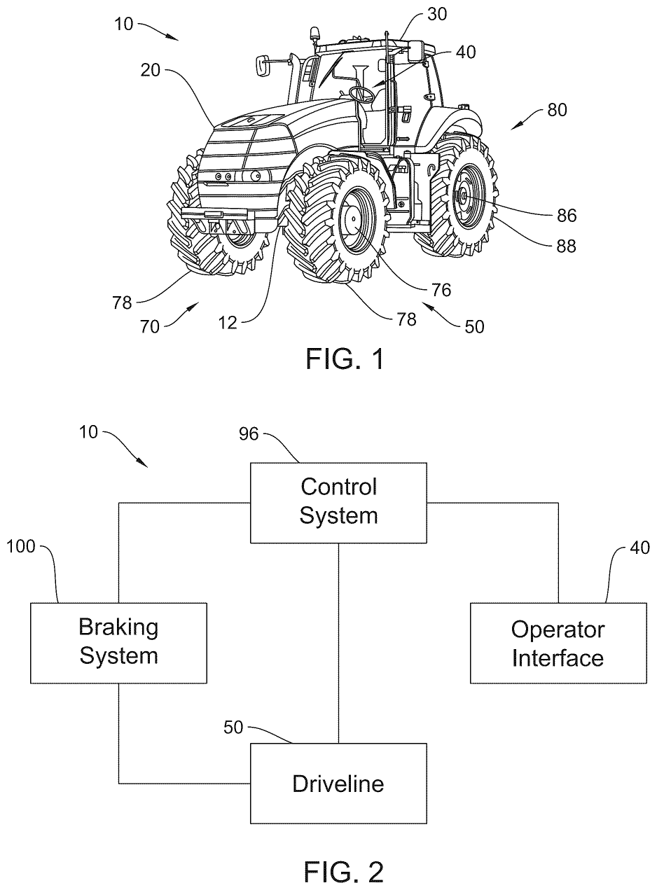

According to the exemplary embodiment shown in FIG. 1-3, a machine or vehicle (e.g., a work machine or work vehicle), shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 100, coupled to one or more components of the driveline 50 to facilitate selectively braking the one or more components of the driveline 50; and a vehicle control system, shown as control system 96, coupled to the operator interface 40, the driveline 50, and the braking system 100. In other embodiments, the vehicle 10 includes more or fewer components.

The chassis of the vehicle 10 may include a structural frame (e.g., the frame 12) formed from one or more frame members coupled to one another (e.g., as a weldment). Additionally or alternatively, the chassis may include a portion of the driveline 50. By way of example, a component of the driveline 50 (e.g., the transmission 52) may include a housing of sufficient thickness to provide the component with strength to support other components of the vehicle 10.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, a LCD display, a LED display, a speedometer, gauges, warning lights, etc. The one or more input device may be or include a steering wheel, a joystick, buttons, switches, knobs, levers, an accelerator pedal, a brake pedal, etc.

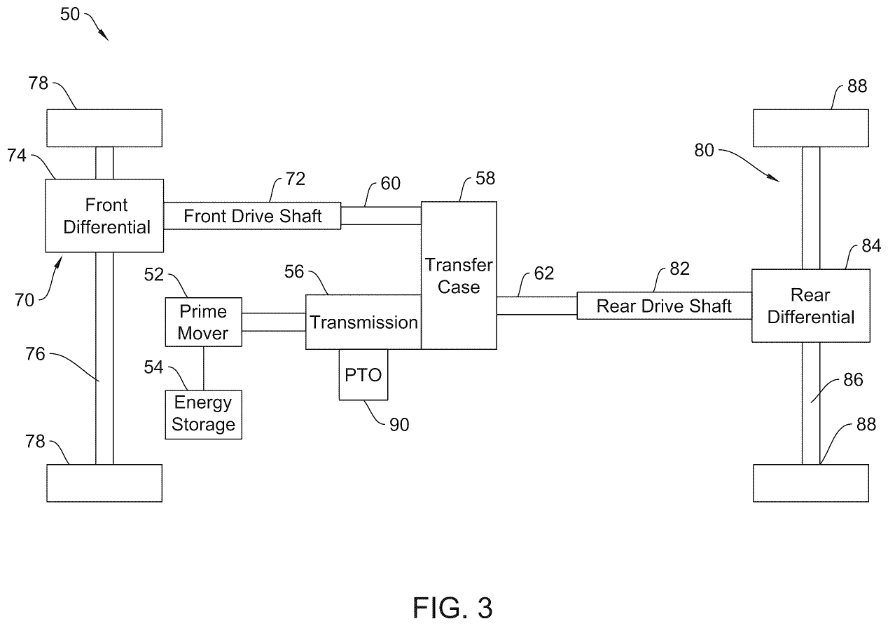

According to an exemplary embodiment, the driveline 50 is configured to propel the vehicle 10. As shown in FIG. 3, the driveline 50 includes a primary driver, shown as prime mover 52, and an energy storage device, shown as energy storage 54. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

As shown in FIG. 3, the driveline 50 includes a transmission device (e.g., a gearbox, a continuous variable transmission (“CVT”), etc.), shown as transmission 56, coupled to the prime mover 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the prime mover 52. In some embodiments (e.g., in electric driveline configurations, in hybrid driveline configurations, etc.), the driveline 50 does not include the transmission 56. In such embodiments, the prime mover 52 may be directly coupled to the transfer case 58. According to an exemplary embodiment, the transfer case 58 is configured to facilitate driving both the front tractive assembly 70 and the rear tractive assembly 80 with the prime mover 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the prime mover 52 (e.g., to permit free movement of the front tractive assembly 70 and the rear tractive assembly 80 in a neutral mode of operation). In some embodiments, the driveline 50 does not include the transfer case 58. In such embodiments, the prime mover 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes a plurality of front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the prime mover 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes a plurality of rear axles 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the prime mover 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of prime movers 52. By way of example, the driveline 50 may include a first prime mover 52 that drives the front tractive assembly 70 and a second prime mover 52 that drives the rear tractive assembly 80. By way of another example, the driveline 50 may include a first prime mover 52 that drives a first one of the front tractive elements 78, a second prime mover 52 that drives a second one of the front tractive elements 78, a third prime mover 52 that drives a first one of the rear tractive elements 88, and/or a fourth prime mover 52 that drives a second one of the rear tractive elements 88. By way of still another example, the driveline 50 may include a first prime mover that drives the front tractive assembly 70, a second prime mover 52 that drives a first one of the rear tractive elements 88, and a third prime mover 52 that drives a second one of the rear tractive elements 88. By way of yet another example, the driveline 50 may include a first prime mover that drives the rear tractive assembly 80, a second prime mover 52 that drives a first one of the front tractive elements 78, and a third prime mover 52 that drives a second one of the front tractive elements 78. In such embodiments, the driveline 50 may not include the transmission 56 or the transfer case 58.

As shown in FIG. 3, the driveline 50 includes a power-take-off (“PTO”), shown as PTO 90. While the PTO 90 is shown as being an output of the transmission 56, in other embodiments the PTO 90 may be an output of the prime mover 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 100 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 100 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

### Terrain-Aware System

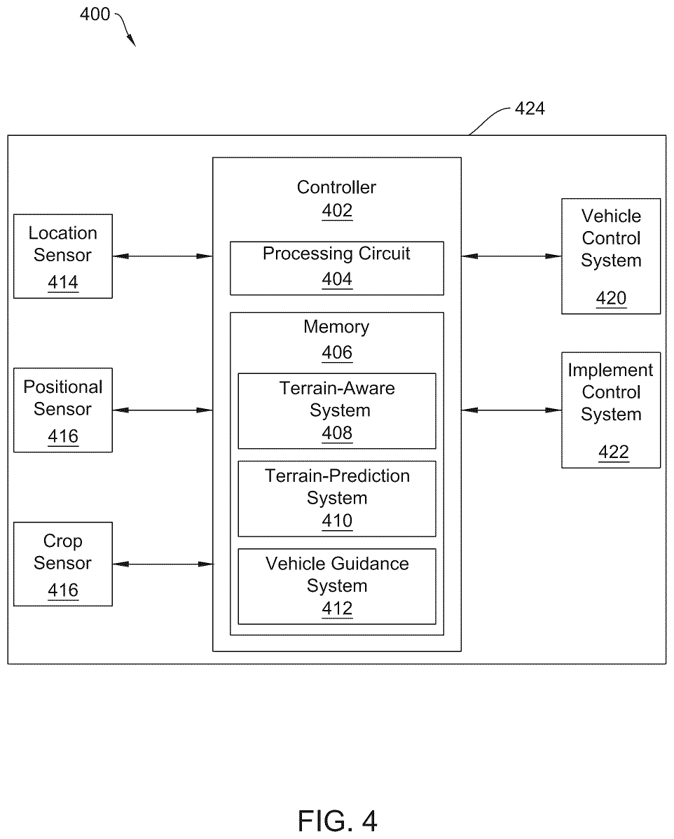

Turning now to FIG. 4, a system 400 is shown. The system 400 may include a vehicle 424 (e.g., the vehicle 10 of FIG. 1) that includes a controller 402, the controller 402 including a processing circuit 404, and a memory 406. The memory 406 may include one or more systems or modules that include instructions in non-transitory computer-readable medium that when executed by the processing circuit 404, cause the processing circuit 404 to perform one or more steps. According to some embodiments, the memory 406 may include a terrain-aware system 408, a terrain-prediction system 410, and a vehicle guidance system 412. In addition to the controller 402, the vehicle 424 may include a location sensor 414 (e.g., a Global Navigational Satellite System (GNSS) receiver), a positional sensor 416, and a crop sensor 418. The vehicle 424 may also include a vehicle control system 420 and an implement control system 422. The location sensor 414 may be any combinations of the sensors including GNSS, IMU, LiDAR, RADAR, SONAR, IR sensor, and the like.

According to some embodiments, the controller 402, through the processing circuit 404, operates functionality of the vehicle 424. The controller 402 may be equipped onboard the vehicle 424 in some embodiments. In other embodiments, the controller 402 may be remote to the vehicle 424 but communicatively coupled to one or more vehicle subsystems (e.g., the vehicle control system 420 and the implement control system 422) responsible for implementation of vehicle 424 or implement operating parameter adjustments. The controller 402 may receive location data from the location sensor 414, positional data from the positional sensor 416, and crop data from the crop sensor 418.

Operating parameters of the vehicle 424 may include, but not be limited to, at least one of steering angle, an engine speed, a transmission gear selection, a hydraulic pressure or flow rate, a traction control, a work mode, a brake force, clutch engagement, implement height, and implement lateral adjustment. In other embodiments, the operating parameters discussed herein (e.g., the operating parameters of the vehicle 424 or otherwise) may include operating parameters of an implement coupled to the vehicle 424. Operating parameters of the implement may include, but not be limited to, at least one of implement steering angle, an implement height, an implement engagement depth, spray amount, spray direction, power take-off engagement, and an implement lateral adjustment. It should be understood that any process describing an adjustment to one or more operating parameters may include any operating parameter described herein, whether of the vehicle 424 or the implement, regardless of the any indication otherwise.

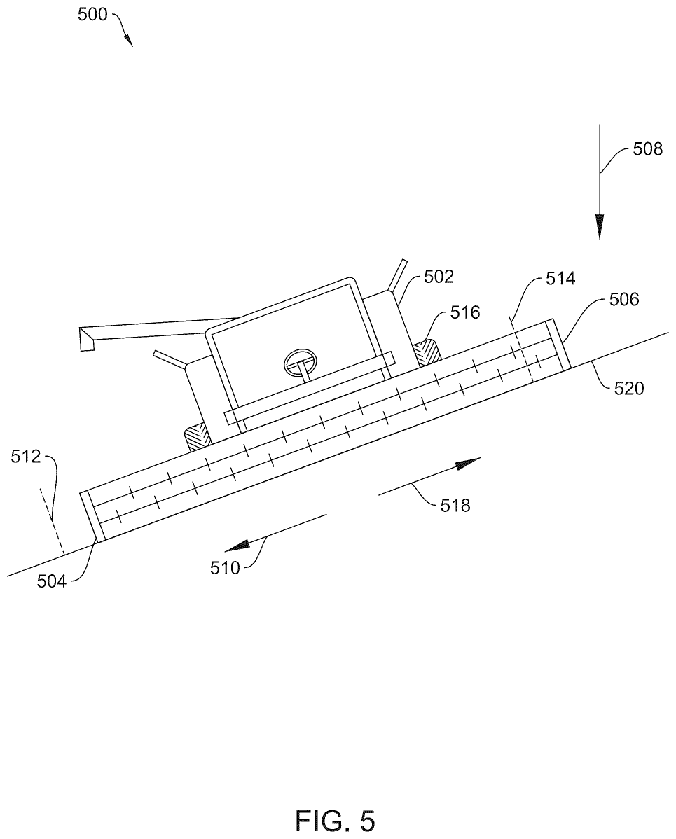

The controller 402 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. The processing circuit 404 may include an ASIC, one or more FPGAs, a DSP, circuits containing one or more processing components, circuitry for supporting a microprocessor, a group of processing components, or other suitable electronic processing components. In some embodiments, the processing circuit 404 is configured to execute computer code stored in the memory 406 to facilitate the activities, methods, and processes described herein. The memory 406 may be any volatile or non-volatile computer-readable storage medium capable of storing data or computer code relating to the activities described herein. According to an exemplary embodiment, the memory 406 includes computer code modules (e.g., executable code, object code, source code, script code, machine code, etc.) configured for execution by the processing circuit 404. The functions and operations of the controller 402 are described in more detail herein with reference to FIGS. 5-8 One exemplary module contained in the memory 406 of FIG. 4 includes the terrain-aware system 408. The terrain-aware system 408 may contain instructions for determining current terrain conditions based, in part, on a positional state of the vehicle 424 and/or geospatial data received from one or more navigational systems (e.g., Global Navigation Satellite Systems (GNSS), GPS, Galileo, etc.). Terrain conditions may include a nominal condition and an anomalous condition. Terrain conditions can further be characterized as divagation conditions (e.g., a slip condition) and non-divagation conditions (e.g., a non-slip condition).

Positional states of the vehicle 424 may include a nominal state, a rolled state, a pitched state, and a yawed state. The rolled state may correspond to the vehicle 424 rotating about a longitudinal axis of the vehicle 424 extending from a front of the vehicle 424 to a back of the vehicle 424. For example, the vehicle 424 may be in the rolled state as it traverses a sloped gradient. The pitched state may correspond to the vehicle 424 rotating about a lateral axis extending from a left side of the vehicle 424 to a right side of the vehicle 424. For example, the vehicle 424 may be in the pitched state when ascending a sloped gradient. The yawed state may correspond to the vehicle rotating about a vertical axis extending from a bottom side of the vehicle 424 to a top side of the vehicle 424. For example, the vehicle 424 may be in the yawed state when turned at an angle from a planned trajectory. The various positional states may span a range of angles, and in an exemplary embodiment, range from 0°-180° and 0°-−180° about the corresponding axes.

A nominal terrain condition (e.g., the nominal condition) may refer to terrain upon which the controller is calibrated for peak performance by default. In an exemplary embodiment, the nominal condition is a flat, dry, compacted terrain, subject to various threshold ranges (e.g., a threshold range of angles from flat, a threshold range of moisture content of the terrain, a threshold range of surface hardness). In some embodiments, the nominal condition is a flat, dry, paved surface. However, it should be understood, that the nominal condition refers to any terrain conditions that the controller 402 is calibrated to make adjustments for by default, and can include sloped, wet, various terrain type, and/or non-level terrain.

Anomalous terrain conditions (e.g., the anomalous condition) may refer to terrain upon which the controller 402 is not calibrated for peak performance by default. In various embodiments, an anomalous condition can refer to any terrain condition that is not the nominal condition. In an exemplary embodiment, an anomalous condition may refer to terrain that is sloped, undulating, mixed materials, wet, sandy, has decreased traction or increased traction, etc. Environmental conditions can also cause anomalous conditions. For example, rain, wind, snow, hail, etc. may cause anomalous conditions that may affect operation of the vehicle 424. Anomalous conditions may be further characterized as divagation conditions and non-divagation conditions (characterizations of the terrain condition, whether nominal or anomalous). The controller 402 is configured to determine both the terrain condition (e.g., nominal condition and anomalous condition) and the further characterizations of the terrain conditions (e.g., divagation condition and non-divagation condition). In some embodiments, the nominal condition is characterized as a non-divagation condition and anomalous conditions can be characterized as a divagation condition or non-divagation condition.

A divagation terrain condition (e.g., the divagation condition) may refer to an anomalous condition that results in an unguided positional adjustment trajectory of the vehicle 424. For example, a divagation terrain condition may be a hill, deluged terrain, gravel, etc. Not all anomalous conditions are characterized as a divagation condition because not all anomalous conditions result in an unguided trajectory or positional adjustment of the vehicle 424.

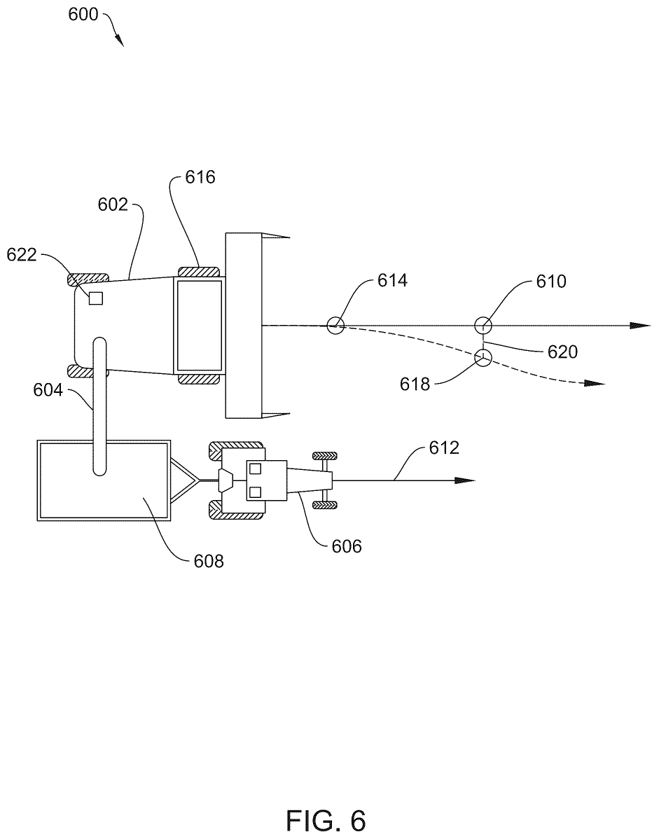

The unguided trajectory adjustment of the vehicle 424 (e.g., unguided positional adjustment trajectory 618 of FIG. 6) may refer, in some embodiments, to drifting off a course due to gravity. For example, a sloped terrain may be an anomalous condition characterized as a divagation condition (referred to, in some embodiments, as an anomalous divagation condition) if a guidance trajectory of the vehicle 424 is traversing the slope (as opposed to descending or ascending the slope), because the vehicle 424 may drift down the slope as it traverses due to gravity (as shown in FIGS. 5-6). In FIG. 5, a vehicle 502 is shown traversing a slope 520 and experiencing a gravitational force 508 causing the vehicle 502 to drift in a direction 510 down the slope 520. In such an embodiment, the slope 520 may be characterized by a controller of vehicle 502 as a divagation condition. However, the same sloped terrain may be determined to be an anomalous condition characterized as a non-divagation condition (referred to, in some embodiments, as an anomalous non-divagation condition) if a guidance trajectory of the vehicle 502 is ascending or descending the slope 520, because the vehicle 502 may not drift off course during ascent or descent of the slope.

In this vein, and returning to FIG. 4, the controller 402 may not necessarily be configured to automatically determine the terrain condition or terrain condition characterization based on a set of terrain parameters (e.g., grade, moisture content, slope, etc.). Rather, the controller 402 determines the terrain condition (e.g., nominal condition and anomalous condition) based on the positional state of the vehicle 424 and/or other environmental data collected from one or more sensors (e.g., humidity, image data, force loads), and the controller 402 determines the characterization of the terrain condition (e.g., divagation condition and non-divagation condition) based on the positional state of the vehicle 424 (as determined by the controller 402) in conjunction with the guidance trajectory of the vehicle 424 (e.g., a guidance trajectory 610 of FIG. 6).

The guidance trajectory (e.g., the guidance trajectory 610 of FIG. 6) may be a predetermined or dynamically updated path upon which the controller is configured operate the vehicle 424 of FIG. 4, by sending control signals to adjust one or more operating parameters to maintain positional accuracy along the guidance trajectory within a predefined distance threshold. These control signals may be sent from the controller 402 to the vehicle control system 420 (e.g., through a data bus), which may, in turn, execute the adjustments through the use of various subsystems and modules, such as the vehicle control system 420 and the implement control system 422 (e.g., the control system 96, the braking system 100, and/or the driveline 50 as illustrated and described in FIG. 2). In some embodiments, the guidance trajectory may include guidance data associated with the direction of travel, the location of travel, the speed of travel, implement operation, obstacles, etc. The vehicle guidance system 412 may contain instructions to cause the processor to read the guidance data in conjunction with the current determined positional state, the determined terrain condition and/or characterization and determine necessary adjustments to be made to one or more operating parameters to maintain the vehicle's 424 operation along the guidance trajectory at a speed and direction indicated (if known). In some embodiments, the vehicle guidance system 412 generates one or more navigation vectors (e.g., a direction and speed) and corresponding operating parameters to navigate along the guidance trajectory. The guidance trajectory may be preloaded into the memory 406 of the controller 402 or may be transmitted by a remote server to the controller 402. In some embodiments, the vehicle guidance system 412 determines the guidance trajectory based on location data from the location sensor 414, position data from the positional sensor 416, and/or crop data from the crop sensor 418.

The terrain-aware system 408 is configured to determine the terrain condition and characterization based, at least in part, on the current positional state of the vehicle 424. The terrain-aware system 408 does this by receiving positional data that is transmitted from the positional sensor 416 along one or more communication means, including wireless communication protocols and/or by wired protocols.

The positional sensor 416 may include any number and/or type of sensors that measure the roll amount, pitch amount, and/or yaw amount of the vehicle 424. In an exemplary embodiment, the positional sensor 416 is an inertial mass unit (“IMU”). In other embodiments, the positional sensor 416 is an accelerometer. In other embodiments, the positional sensor 416 is an image sensor, configured to capture data corresponding to a field of view of the image sensor. In yet another embodiment, the positional sensor 416 may be a GNSS sensor. The positional sensor 416 may be any combinations of the sensors above or otherwise, such as LiDAR, RADAR, SONAR, IR sensor, and the like.

The IMU may be a device used to measure and report specific forces, angular rates, and/or magnetic fields surrounding the device, using a combination of accelerometers, gyroscopes, and magnetometers. The information about the orientation, velocity, and gravitational forces acting upon an object. The accelerometer may measure linear acceleration along the device's axes, allowing it to detect changes in velocity or inclination. The gyroscopes may measure angular velocity or rotational rate, providing information about changes in orientation. Magnetometers measure the strength and direction of magnetic fields, aiding in determining orientation relative to the Earth's magnetic field.

The positional sensor 416 (e.g., the IMU) may be positionally (e.g., physically) coupled to the vehicle 424 and provides positional data of the vehicle 424 to the controller 402 based on measured movements of the positional sensor 416 (and by extension, the vehicle 424) at regular intervals. The positional sensor 416 may be configured to measure an amount of angular rotation (e.g., roll amount, pitch amount, yaw amount) as well as a rate of change of the angular rotation. In some embodiments, the positional sensor 416 may be configured to measure linear movement of the vehicle 424 along the longitudinal axis, the lateral axis, and/or the vertical axis.

The controller 402 (e.g., the terrain-aware system 408 of the controller 402) receives this transmitted incoming positional data of the vehicle 424 and executes one or more processes (e.g., algorithms, table look ups, comparisons, server queries) to determine a corresponding positional state of the vehicle 424. For example, the terrain-aware system 408 may determine that the vehicle 424 is in a rolled state when the terrain-aware system 408 receives an indication of a roll amount above a roll threshold from the positional sensor 416. The terrain-aware system 408 may determine that the vehicle 424 is in a pitched state when the terrain-aware system 408 receives an indication of a pitch amount above a pitch threshold from the positional sensor 416. The terrain-aware system 408 may determine that the vehicle 424 is in a yawed state when the terrain-aware system 408 receives an indication of a yaw amount above a yaw threshold from the positional sensor 416. The terrain-aware system 408 may then determine a current terrain condition on which the vehicle 424 is operating based on the determined, corresponding positional state of the vehicle 424. By way of example, if the terrain-aware system 408 determines that the vehicle 424 is in a rolled state, the terrain-aware system 408 may determine that the current terrain condition on which the vehicle 424 is operating is an anomalous divagation terrain condition. If the terrain-aware system 408 determines that the vehicle 424 is in a nominal state (e.g., within a nominal roll threshold, a nominal pitch threshold, and/or a nominal yaw threshold), the terrain-aware system 408 determines that the current terrain condition on which the vehicle 424 is operating is a nominal terrain condition.

In some embodiments, the terrain-aware system 408 automatically characterizes, in response to determining that the vehicle 424 is operating on a nominal terrain condition, the nominal terrain condition as a non-divagation condition. As such, when the terrain-aware system 408 determines that the vehicle 424 is operating on the nominal terrain condition, the terrain-aware system 408 does not use the guidance trajectory and/or associated guidance data to further determine the classification of the terrain condition. In such cases, the vehicle guidance system 412 may generate a navigation vector with corresponding operating parameter adjustments to operate the vehicle 424 along the guidance trajectory without any compensation for divagation.

In response to the terrain-aware system 408 determining that the vehicle 424 is operating on an anomalous condition (based, at least in part, on the determined positional state of the vehicle 424), the terrain-aware system 408 continues by determining the classification of the anomalous condition (e.g., an anomalous divagation condition or an anomalous non-divagation condition). In some embodiments, the terrain-aware system 408 uses both the positional data, the determined positional state, and/or the guidance trajectory (and associated guidance data) to determine the classification of the anomalous condition. In some embodiments, the terrain-aware system 408 may only use the positional data and/or positional state to determine the classification of the anomalous condition.

FIG. 5 shows a system 500 in which a vehicle 502 (e.g., a combine harvester) is operating along an anomalous divagation condition (e.g., traversing a steep side slope 520). According to an embodiment, the vehicle 502 may include a controller, sensors, and systems substantially similar to the vehicle 424 of FIG. 4 and the vehicle 602 of FIG. 6. Returning to FIG. 5, the gravitational force 508 acts upon the vehicle 502 and causes the vehicle 502 to drift down the slope 520 in the direction 510 as the vehicle 502 is automatically guided along a guidance trajectory (e.g., the guidance trajectory 610 of FIG. 6). The drift may cause the vehicle 502 to travel along an unguided positional adjustment trajectory (e.g., the unguided positional adjustment trajectory 618 of FIG. 6) that is positionally inaccurate to the guidance trajectory. According to an embodiment, a far-left component of the vehicle 502 shifts from position 506 to position 514 as the vehicle 502 drifts along the unguided positional adjustment trajectory. In similar fashion, the far-right component of the vehicle 502 shifts from position 504 to position 512 as the vehicle 502 drifts along the unguided positional adjustment trajectory. In such an embodiment, a terrain-aware system (e.g., the terrain-aware system 408 of FIG. 4) of the vehicle 502 of FIG. 5 may determine, based on received positional data from a position sensor onboard the vehicle 502 (e.g., the positional sensor 416 of FIG. 4), that the vehicle 502 of FIG. 5 is operating along the anomalous divagation condition and transmit an indication to a terrain-prediction system (e.g., the terrain-prediction system 410 of FIG. 4) of the vehicle 502 to predict future terrain conditions along the guidance trajectory. In various embodiments, the terrain-aware system of the vehicle 502 uses one or more data filtering techniques to filter the incoming positional data. The terrain-aware system then determines the current positional state of the vehicle 502 based, at least in part, on the filtered plurality of incoming positional data.

Returning back to FIG. 4, and by way of a first example, the positional sensor 416 of the vehicle 424 senses an angular rotation about a longitudinal axis of the vehicle 424. The positional sensor 416 generates positional data corresponding to this sensed angular rotation (e.g., roll data) and transmits the positional data to the controller 402. The terrain-aware system 408 of the controller 402 receives the transmitted positional data and interprets the transmitted positional data to determine a positional state of the vehicle 424. In the first example, the positional data indicates that the vehicle 424 is rolled 4° about the longitudinal axis of the vehicle 424. In the example, a nominal terrain condition is flat and corresponds to a nominal state of the vehicle 424 (e.g., a positional state in which the vehicle 424 is within 5° rotation about the longitudinal axis of the vehicle 424). Because the vehicle 424 is within the 5° rotation threshold about the longitudinal axis, the terrain-aware system 408 determines that the vehicle 424 is in the nominal state. The terrain-aware system 408 determines that because the vehicle 424 is in the nominal state, the vehicle 424 is operating on a nominal terrain condition. In response to determining that the vehicle 424 is operating on nominal terrain condition, the terrain-aware system 408 determines that the vehicle 424 is not traveling on a divagation condition and the vehicle guidance system 412 determines no compensation adjustments need be made to any operating parameters of the vehicle 424 to maintain positional accuracy with the guidance trajectory.

By way of a second example, the positional sensor 416 of the vehicle 424 senses an angular rotation about a longitudinal axis of the vehicle 424. The positional sensor 416 generates positional data corresponding to this sensed angular rotation (e.g., roll data) and transmits the positional data to the controller 402. The terrain-aware system 408 of the controller 402 receives the transmitted positional data and interprets the transmitted positional data to determine a positional state of the vehicle 424. In the second example, the positional data indicates that the vehicle 424 is rolled 7° about the longitudinal axis of the vehicle 424. In the example, a nominal terrain condition is flat and corresponds to a nominal state of the vehicle 424 (e.g., a positional state in which the vehicle 424 is within 5° rotation about the longitudinal axis of the vehicle 424). Because the vehicle 424 is outside the 5° rotation threshold about the longitudinal axis, the terrain-aware system 408 determines that the vehicle 424 is in a rolled state. The terrain-aware system 408 determines that because the vehicle 424 is in the rolled state, the vehicle 424 is operating on an anomalous terrain condition. In response to determining that the vehicle 424 is operating on the anomalous terrain condition, the terrain-aware system 408 continues to determine whether the anomalous terrain condition that the vehicle 424 is operating on is a divagation condition or a non-divagation condition. In one embodiment of the second example, the terrain-aware system 408 determines that because the vehicle 424 is in a rolled state, the vehicle 424 may be traversing a sloped gradient, which may result in divagation condition. Upon receiving and filtering a plurality of positional data over a period of time (e.g., 2 seconds) that indicate the rolled amount of 7°, the terrain-aware system 408 determines that the vehicle 424 is traversing a sloped gradient and, as such the vehicle 424 is likely to encounter an unguided positional adjustment (e.g., drift down the hill). In making this determination, the vehicle 424 determines that the vehicle 424 is traveling on an anomalous divagation condition and transmits an indication (and/or instructions) of the determined classification to the terrain-prediction system 410 to predict future terrain conditions and/or to the vehicle guidance system 412 to determine compensation adjustments for the divagation condition. In a second embodiment of the second example, the terrain-aware system 408 uses the guidance data associated with the guidance trajectory in conjunction with the determined positional state to determine the terrain condition and associated classification.

By way of a third example, the positional sensor 416 of the vehicle 424 senses an angular rotation about a lateral axis of the vehicle 424. The positional sensor 416 generates positional data corresponding to this sensed angular rotation (e.g., pitch data) and transmits the positional data to the controller 402. The terrain-aware system 408 of the controller 402 receives the transmitted positional data and interprets the transmitted positional data to determine a positional state of the vehicle 424. In the third example, the positional data indicates that the vehicle 424 is pitched about 7° about the lateral axis of the vehicle 424. In the third example, a nominal terrain condition is flat and corresponds to a nominal state of the vehicle 424 (e.g., a positional state in which the vehicle 424 is within 5° rotation about the lateral axis of the vehicle 424). Because the vehicle 424 is outside the 5° rotation threshold about the lateral axis, the terrain-aware system 408 determines that the vehicle 424 is in a pitched state. The terrain-aware system 408 determines that because the vehicle 424 is in the pitched state, the vehicle 424 is operating on an anomalous terrain condition. In response to determining that the vehicle 424 is operating on the anomalous terrain condition, the terrain-aware system 408 continues to determine whether the anomalous terrain condition that the vehicle 424 is operating on is a divagation condition or a non-divagation condition. In one embodiment of the second example, the terrain-aware system 408 determines that because the vehicle 424 is in a pitched state, the vehicle 424 may be ascending a sloped gradient, which may not result in divagation condition. Upon receiving and filtering a plurality of positional data over a period of time (e.g., 5 seconds), the terrain-aware system 408 determines that the vehicle 424 is ascending a sloped gradient and, as such, the vehicle 424 is unlikely to encounter an unguided positional adjustment. In making this determination, the vehicle 424 determines that the vehicle 424 is traveling on an anomalous non-divagation condition and transmits an indication (and/or instructions) of the determined classification to the vehicle guidance system 412. In a second embodiment of the second example, the terrain-aware system 408 uses the guidance data associated with the guidance trajectory in conjunction with the determined positional state to determine the terrain condition and associated classification.

The terrain-aware system 408 determines the positional state and corresponding terrain condition and characterization on the fly. In some embodiments, the terrain-aware system 408 receives positional data from the positional sensor 416 at regular intervals (e.g., every millisecond, every second, every 5 seconds, etc.). The terrain-aware system 408 applies one or more filtering protocols to the received positional data to filter the received positional data and determine the positional state of the vehicle 424 based on the filtered data to more accurately determine the current positional state of the vehicle 424 as opposed to updating the positional state of the vehicle 424 based on each measured micromovement of the vehicle. In some embodiments, the positional data is filtered based on amount of movement and/or filtered over time.

### Terrain-Prediction System

In some embodiments, the controller 402 includes the terrain-prediction system 410. The terrain-prediction system 410 may be configured to predict (e.g., estimate) one or more approaching terrain conditions and characterizations (and associated ground location) over a short prediction horizon (e.g., 1-60 seconds). The terrain-prediction system 410 may receive an indication from the terrain-aware system 408 of the determined current terrain condition and characterization. With the current terrain condition and characterization, the terrain-prediction system 410 may predict approaching anomalous divagation conditions that could result in unguided positional adjustments to the vehicle 424 based on current position state, current terrain condition and characterization, navigational vector, and/or the guidance trajectory.

For example, the terrain-prediction system 410 may predict an approaching divagation condition (with corresponding ground position) that may lead to an unguided positional adjustment (e.g., drifting down a slope) over a period of time (e.g., 3 seconds) that may result in the vehicle 424 ending at an inaccurate position with regard to the guidance trajectory (e.g., 10 feet to the side). In the second example above, in which the terrain-aware system 408 determined that the vehicle 424 was operating on the anomalous divagation condition, the terrain-aware system 408 may transmit an indication to the terrain-prediction system 410 of the current positional state and the current terrain condition and characterization. Upon receiving the indication, by the terrain-prediction system 410, the terrain-prediction system 410 executes one or more predictive models to predict a result of the anomalous divagation condition on the vehicle 424 over a period of time and the expected/predicted terrain conditions along the ground positions spanning the guidance trajectory upon which the vehicle 424 is operating. The terrain-prediction system 410 makes the prediction of the effect of the current anomalous divagation condition on the vehicle 424 and the predicted, approaching divagation conditions based at least on the received indication of the positional state, the terrain condition and characterization, and/or the guidance trajectory and associated guidance data, such as shown in FIG. 6.

Turning now to FIG. 6, a system 600 is shown in which a terrain-prediction system predicts an unguided positional adjustment trajectory 618. The system 600 may include a vehicle 602 (e.g., a harvesting combine), a vehicle 606 (e.g., a tractor), and/or a collector 608. The vehicle 602 may include a throwing device 604 and at least one tractive element 616. In such embodiments, the vehicle 602 may be substantially similar to the vehicle 424 of FIG. 4, including a controller 622, a processor, memory, a terrain-aware system, a terrain-prediction system, a vehicle guidance system, a location sensor, a positional sensor, a vehicle control system, and/or an implement control system. In some embodiments, the controller 622 is substantially similar to the controller 402 of FIG. 4.

As shown in FIG. 6, the vehicle 602 may be configured to travel along a guidance trajectory 610 based on control signals sent to the various control subsystems by the vehicle guidance system. In tandem, the vehicle 606 may travel along a parallel (or substantially parallel) guidance trajectory 612. In a default positional state (e.g., a nominal state or level positional state), or in operating along nominal terrain conditions, the vehicle guidance system sends control signals to the various subsystems to follow the guidance trajectory without any compensation for predicted unguided positional adjustments. In such embodiments, the controller nominally operates the vehicle, or in other words, operates the vehicle without compensation adjustments. However, upon the terrain-aware system of the vehicle 602 determining that the vehicle 602 is traveling (or will travel) over an anomalous divagation condition 614 based on received and filtered positional data, the terrain-prediction module of the vehicle 602 predicts an unguided positional adjustment trajectory 618 of the vehicle 602 and a resulting unguided position adjustment 620 from the guidance trajectory 610.

### Vehicle Guidance System

Responsive to predicting the unguided positional adjustment trajectory 618 and resulting unguided position adjustment 620, the vehicle guidance system (e.g., the vehicle guidance system 412 of FIG. 4) of the vehicle 602 dynamically adjusts the guidance trajectory 610 to compensate for the predicted unguided positional adjustment trajectory 618. This updated guidance trajectory may be considered a compensation trajectory. The vehicle guidance system then determines terrain-specific compensation adjustments to one or more operating parameters of the vehicle (e.g., adjusting the steering angle of the one or more tractive elements 616 of the vehicle 602) to preemptively compensate for the predicted unguided positional adjustment trajectory 618 and “travel” along the updated guidance trajectory. It should be noted that the compensation trajectory is not traveled upon, rather, the vehicle 602 makes adjustments to the operating parameters of the vehicle (or coupled implement) as if it were traveling along the compensation trajectory, but the predicted divagation affects the position of the vehicle 602 such that the vehicle 602 continues along the original guidance trajectory 610.

The vehicle guidance system calculates and predicts needed adjustments to one or more operating parameters of the vehicle 602 to maintain positional accuracy of the vehicle 602 along the guidance trajectory 610. The vehicle guidance system transmits control signals corresponding to the predicted needed adjustments of the operating parameters to the associated subsystems of the vehicle 502 to execute the needed adjustments. In the embodiment shown in FIG. 5, the needed adjustments may include adjusting the steering angle of the one or more tractive elements 516 to adjust the vehicle 502 in a direction 518 up the slope 520, compensating for the gravitational drift in the direction 510 down the slope 520 as the vehicle 502 traverses the slope 520. As discussed herein, the vehicle guidance system initiates compensation adjustments to the operating parameters preemptively (e.g., prior to arriving at the ground position of the predicted anomalous divagation condition) in order to prevent drift (e.g., gravitational drift) from occurring.

Returning to FIG. 6, the vehicle guidance system of the vehicle 602 may also take into account additional external factors when determining compensation adjustments to operating parameters. For example, as shown in FIG. 6, the vehicle 602 (e.g., a combine harvester) may be working in tandem with the vehicle 606 (e.g., a tractor towing a collector 608, such as an open-top trailer) when operating along the guidance trajectory 610, such as when harvesting. In such embodiments, in which the vehicle 602 is working in tandem with the vehicle 606, the vehicle guidance system of the vehicle 602 restricts the compensation adjustments to guidance trajectory and/or the operating parameters. This may be due to a limited reach of the throwing device 604 which is used to discharge the harvested crop into the collector 608. In embodiments in which the compensation adjustments are limited, the limits may be based on throw reach of the throwing device 604 such that the harvested crop remains being discharged into the collector 608. In other embodiments, the limits may be imposed so that the vehicle 602 does not overly compensate in such a way as to cause a collision with the vehicle 606 and/or the collector 608.

In addition to generating the compensation trajectory for the vehicle 602, the vehicle guidance system may also determine the original guidance trajectory 610. The vehicle guidance system may receive location data from a location sensor/receiver (e.g., the location sensor 414 of FIG. 4) equipped on the vehicle 602 of FIG. 6. This location data may indicate geospatial coordinate locations of the vehicle 602 and/or geospatial coordinate locations of a predetermined guidance trajectory. The vehicle guidance system then uses this received location data to generate operating parameter adjustments needed to maintain the vehicle 602 operating along the guidance trajectory 610.

The vehicle guidance system may also take into account one or more external factors when generating the compensation trajectory. Such factors may include increase moisture in the terrain which may lead to increased divagation. In other embodiments, the vehicle guidance system takes into account crop location when determining guidance and compensation trajectories.

### Crop Avoidance

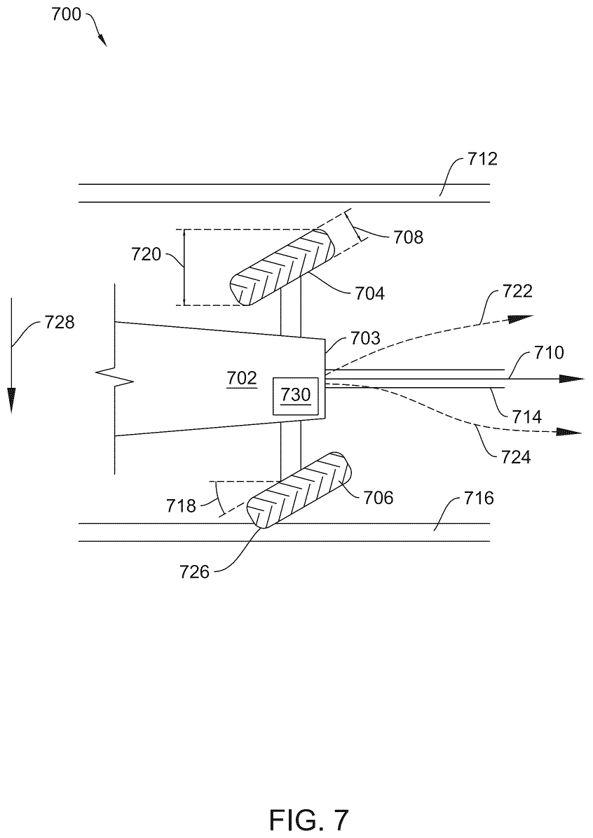

Turning now to FIG. 7, a crop avoidance system 700 is shown. A vehicle 702 is shown with a first tractive element 704 having a width 708 and a second tractive element 706. The vehicle 702 may include a controller (e.g., the controller 402 of FIG. 4), various subsystems (e.g., the vehicle control system 420 of FIG. 4 and the implement control system 422 of FIG. 4), and one or more sensors (e.g., the location sensor 414 of FIG. 4, the positional sensor 416 of FIG. 4, and/or the crop sensor 418 of FIG. 4). In various embodiments, the vehicle 702 is substantially similar to the vehicle 424 of FIG. 4. As shown in FIG. 7, the vehicle 702 is traveling along a guidance trajectory 710 with the first tractive element 704 and the second tractive element 706 positioned between crop rows 712, 714, 716. The first tractive element 704 is positioned between the crop row 712 and the crop row 714, while the second tractive element 706 is positioned between the crop row 714 and the crop row 716.

According to some embodiments, the vehicle 702 may include a crop sensor 730. The crop sensor 730 may include an image sensor and corresponding image interpretative systems (e.g., executed by the controller). The crop sensor 730 may capture data related to the location crops in relation to the vehicle 702. For example, the crop sensor 730 may capture images of one or more crops in the crop rows 712, 714, 716. These images may be transmitted to the controller of the vehicle 702. In some embodiments, the controller of the vehicle 702 executes a terrain-aware system (e.g., the terrain-aware system 408 of FIG. 4). In such embodiments, the terrain-aware system may interpret crop data (e.g., crop images) received from the crop sensor 730 to generate a map of crops surrounding the vehicle 702. The terrain-aware system may transmit the generated map of crops to the vehicle guidance system to influence the determination of needed operational parameter compensation adjustments. In embodiments in which crop data and/or the generated crop map influences the determination of needed operational parameter compensation adjustments, the compensation adjustments are limited by the position of the crops, as indicated by the generated crop map and received crop data. In some embodiments, the limits are imposed to prevent the first tractive element 704 and/or the second tractive element 706 from colliding with the crop rows 712, 714, 716, such as at collision point 726. In other embodiments, the limits are imposed to prevent a portion of the vehicle 702 from colliding with the crop rows 712, 714, 716. Yet in other embodiments, the limits are imposed to navigate the vehicle 702 in a trajectory to optimally harvest the crop. This may entail navigating the vehicle 702 such that a cutter head of the vehicle 702 maximizes its cut per pass during harvesting. In some embodiments, to ensure that the full width (or the largest amount of the width) of the cutter head of the vehicle 702 is engaging with the crop to be harvested (e.g., the crops in the crop rows 712, 714, 716).

In some embodiments, a compensation trajectory 722 and/or the guidance trajectory 710 is dynamically generated by the controller based on the received crop data from the crop sensor. In some embodiments, the dynamically generated guidance trajectory 710 is based on past harvesting passes of a field. For example, the dynamically generated guidance trajectory 710 may be generated to continually harvest row-by-row (or rows-by-rows), moving laterally across the field with each harvesting pass.

In some embodiments, the vehicle 702 may receive instructions from the vehicle guidance system to adjust a steering angle 718 to a position as shown in FIG. 7. In this configuration, with the tractive elements 704, 706 adjusted to the steering angle 718, the second tractive element collides with the crop row 716 at collision point 724. In a nominal setting in which the steering angle 718 is 0° (e.g., directing the vehicle 702 in a straight line along the guidance trajectory 710), the second tractive element 706 does not collide with the crop row 716 at the collision point 726. However, when the steering angle 718 is set to the position as shown in FIG. 7 a collision occurs. In some embodiments, the tractive elements 704, 706 maintain the steering angle 718 while the vehicle 702 maintains course along the guidance trajectory 710. This may occur when the vehicle 702 experiences gravitational force towards direction 728 (e.g., when traversing a side hill). In this embodiment, the steering angle 718 of the vehicle 702 equally compensates for the drift that would occur without the steering angle 718 due to gravitational forces, thus maintaining a straight (and positionally accurate) trajectory despite the steering angle 718. In such embodiments, the width of the tractive elements that may come into contact with the crops (e.g., the area crossed) widens from a width 708 to an increased width 720. The terrain-aware system, a terrain prediction system, and the vehicle guidance system of the vehicle 702 may be configured to calculate this widening to the increased width 720 and take the additional width into consideration when determining compensating adjustments to the operating parameters of the vehicle 702 and when dynamically determining the guidance trajectory 710 so as to not collide with the crop rows 712, 714, 716. The compensation adjustments determined and transmitted by the controller of the vehicle 702 (by way of the terrain-aware system, the terrain prediction system, and the vehicle guidance system) may be configured to cause the vehicle to operate as if it were traveling along the compensation trajectory 722, were it not for the unguided positional adjustments (due, for example, to gravitational forces) that affect the vehicle during anomalous divagation conditions.

In some embodiments, the vehicle guidance system transmits instructions to an operator interface with indications of one or more operating parameter adjustments. In such embodiments, an operator of the vehicle 702 may manually make adjustments through the operator interface. In other embodiments, the vehicle guidance system transmits instructions to an implement control system (e.g., the implement control system 422 of FIG. 4) to make operating parameter adjustments to a towed implement coupled to the vehicle 702 of FIG. 7. The implement control system may be equipped on the vehicle 702 or the coupled implement.

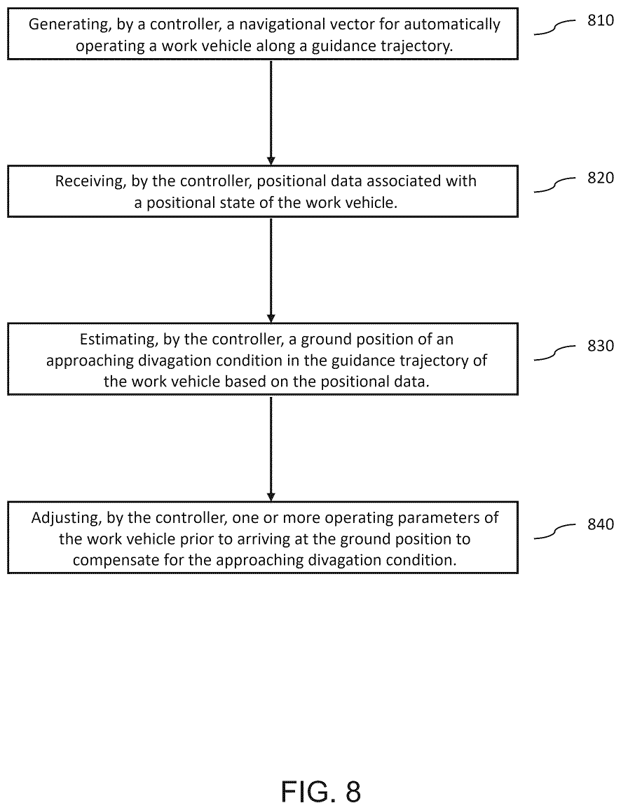

Turning now to FIG. 8, a flow chart of an example computer-implemented method for preemptively adjusting an operation of a vehicle to automatically compensate for an approaching divagation condition predicted at a ground location along a guidance trajectory of the vehicle.

At step 810, a controller generates a navigational vector for automatically operating a work vehicle along a guidance trajectory. The navigational vector may include indications of a direction and speed for the vehicle to operate to travel along the guidance trajectory. The navigational vector may continuously and dynamically be updated as the vehicle operates along the guidance trajectory. The controller may include one or more modules and/or systems, as described herein, to generate the navigational vector. In some embodiments, the navigational vector is generated by a vehicle guidance system. According to an embodiment, the work vehicle guidance system generates a navigational vector based on a predetermined or dynamically updated guidance trajectory received or generated by the vehicle guidance system, the navigational vector determined based on a nominal state of the work vehicle (e.g., operating in a straight line on flat, compacted terrain).

At step 820, the controller receives positional data associated with a positional state of the work vehicle. The work vehicle has physically coupled to it one or more positional sensors. The one or more positional sensors may include IMUs, accelerometers, gyroscopes, cameras, compasses, magnetic switches, etc. The positional sensors sense physical movements of the work vehicle, such as rotations about one or more axes of the work vehicle. These rotations may be considered roll, pitch, and/or yaw. The data collected by the one or more positional sensors may be associated with a roll amount, a pitch amount, and/or a yaw amount and their corresponding rate of changes.

These positional data may be transmitted by the positional sensor to a terrain-aware system (e.g., the terrain-aware system 408 of FIG. 4). As described in FIG. 4, the terrain-aware system may receive the transmitted positional data, filter the plurality of incoming data over a period of time, and determine, based at least partly on the filtered positional data, a positional state of the work vehicle.

At step 830, the controller estimates a ground position of an approaching divagation condition in the guidance trajectory of the work vehicle based on the positional data. After determining the positional state of the work vehicle (e.g., a rolled state, a pitched state, and/or a yawed state), a terrain-prediction system (e.g., the terrain-prediction system 410 of FIG. 4) predicts approaching terrain conditions at corresponding ground positions along the guidance trajectory. Terrain conditions may include nominal terrain conditions (e.g., nominal conditions) and/or anomalous terrain conditions (e.g., anomalous conditions). The terrain conditions can further be characterized, by the terrain-prediction system, as divagation conditions or non-divagation conditions. Divagation conditions are terrain conditions that may result in unguided positional adjustments (e.g., drifting down a hill while traversing the hill). Non-divagation conditions are terrain conditions that likely will not result in unguided positional adjustments. Both nominal conditions and anomalous conditions may be characterized as either a divagation condition or a non-divagation condition. In some embodiments, nominal conditions are non-divagation. Nominal conditions may be defined as conditions for which the controller of the work vehicle is optimized for operating under (e.g., nominal operation). By way of example, nominal conditions may be flat, dry, and compacted terrain. Anomalous conditions may be defined as any terrain conditions that are not nominal, and as such, the controller is not optimized, by default, to operate under these conditions.

At step 840, the controller adjusts one or more operating parameters of the work vehicle prior to arriving at the ground position to compensate for the approaching divagation condition. In order to achieve optimal performance in all terrain conditions, both nominal and anomalous, the controller (by way of a vehicle guidance system, such as the vehicle guidance system 412 of FIG. 4) determines a compensatory adjustment to compensate for the predicted divagation condition upon which the work vehicle is predicted to traverse. The operating parameters adjusted may be a steering angle, a gear engagement, a differential engagement, a throttle position, a brake position, etc. The determined compensation adjustments are then transmitted to the various vehicle subsystems to execute the compensation adjustments. In some embodiments, the operator of the vehicle may adjust one or more parameters of the vehicle guidance system to selectively choose the aggressiveness of the compensation and prediction horizon (e.g., the amount of time that the terrain-prediction system predicts terrain conditions out to). The user may use sliders, for example to adjust the aggressiveness of the compensation and the prediction horizon. Responsive to receiving an indication of a compensation aggressiveness and/or prediction horizon, the controller adjusts the aggressiveness of the compensation adjustments and/or the prediction horizon, in line with the received respective indications.

When determining guidance trajectories, compensation trajectories, and/or operating parameter adjustments, the controller may based its determinations on the location data, the crop data, and/or a combination of the location data and the crop data. In some embodiments, the controller uses location data by default but uses crop data if the crop data is available (or a crop mode is engaged).

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments and that such variations are intended to be encompassed by the present disclosure.

The hardware and data processing components used to implement the various computer-implemented processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular and methods processes (e.g., computer-implemented methods and process) may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

It is important to note that the construction and arrangement of the vehicle 10 and the systems and components thereof (e.g., the driveline 50, the braking system 100, the control system 96, etc.) as shown in the various exemplary embodiments is illustrative only. Additionally, any element disclosed in one embodiment may be incorporated or utilized with any other embodiment disclosed herein.

What is claimed is:

1. A computer-implemented method comprising:
generating, by a controller, a navigational vector for automatically operating a work vehicle along a guidance trajectory;
receiving, by the controller, positional data associated with a positional state of the work vehicle;
estimating, by the controller, a ground position of an approaching divagation condition in the guidance trajectory of the work vehicle based on the positional data; and
adjusting, by the controller, one or more operating parameters of the work vehicle prior to arriving at the ground position to compensate for the approaching divagation condition.

2. The computer-implemented method of claim 1, further comprising:
receiving, by the controller, geospatial data from a Global Navigational Satellite System (GNSS) receiver communicatively coupled to the controller, wherein the navigational vector is based, in part, on the geospatial data.

3. The computer-implemented method of claim 1, further comprising:
receiving, by the controller, crop data from a crop sensor communicatively coupled to the controller, wherein the navigational vector is based, in part, on the crop data.

4. The computer-implemented method of claim 1, further comprising:
receiving, by the controller, geospatial data from a Global Navigational Satellite System (GNSS) receiver communicatively coupled to the controller; and
receiving, by the controller, crop data from a crop sensor communicatively coupled to the controller,
wherein the navigational vector is based, in part, on the geospatial data and, when crop data is available, the crop data.

5. The computer-implemented method of claim 1, wherein the positional data includes at least one of a roll amount, a pitch amount, a yaw amount, a rate of change of roll, a rate of change of pitch, and a rate of change of yaw.

6. The computer-implemented method of claim 1, further comprising:
receiving, by the controller, a plurality of incoming positional data of the work vehicle over a period of time;
filtering, by the controller, the plurality of incoming positional data of the work vehicle over the period of time; and
estimating, by the controller, the positional state of the work vehicle based on the filtered plurality of incoming positional data over the period of time.

7. The computer-implemented method of claim 1, wherein the approaching divagation condition includes a slip condition in which the work vehicle performs an unguided positional adjustment over terrain.

8. The computer-implemented method of claim 1 wherein the controller nominally operates the work vehicle in a default positional state, in which the default positional state is a level positional state.

9. The computer-implemented method of claim 1, further comprising:
generating, by the controller, an updated guidance trajectory based on an adjustment of the one or more operating parameters.

10. The computer-implemented method of claim 1, further comprising:
generating, by the controller, an updated guidance trajectory based on an adjustment of a steering angle of a tractive element of the work vehicle, wherein the updated guidance trajectory compensates for an increased width of an area crossed by the tractive element of the work vehicle during the adjustment of the steering angle of the tractive element of the work vehicle.

11. The computer-implemented method of claim 1, wherein the one or more operating parameters is a steering angle.

12. The computer-implemented method of claim 1, wherein the approaching divagation condition is one of a hill, a furrow, an incline, a ditch, an area of reduced traction, and an area of increased traction.

13. The computer-implemented method of claim 1, wherein the controller adjusts the one or more operating parameters to compensate for the approaching divagation condition such that an implement coupled to the work vehicle maintains the guidance trajectory.

14. The computer-implemented method of claim 1, wherein the controller adjusts the one or more operating parameters to compensate for the approaching divagation condition such that the work vehicle maintains the guidance trajectory.

15. The computer-implemented method of claim 1, wherein the work vehicle is one of a tractor, a combine, and a speedrower.

16. A system comprising,
a work vehicle;
a positional sensor; and
a controller, the controller comprising one or more processors including one or more memory devices coupled to the one or more processors, the one or more memory devices configured to store instructions thereon that, when executed by the one or more processors, cause the one or more processors to:
receive a navigational vector for automatically operating a work vehicle along a guidance trajectory;
receive positional data associated with a positional state of the work vehicle;
estimate a ground position of an approaching divagation condition in the guidance trajectory of the work vehicle based on the positional data; and
adjust one or more operating parameters of the work vehicle prior to arriving at the ground position to compensate for the approaching divagation condition.

17. The system of claim 16, wherein the one or more memory devices are configured to store further instructions thereon that, when executed by the one or more processors, cause the one or more processors to:
receive a plurality of incoming positional data of the work vehicle over a period of time;
filter the plurality of incoming positional data of the work vehicle over the period of time; and
estimate the positional state of the work vehicle based on the filtered plurality of incoming positional data over the period of time.

18. The system of claim 16, wherein the one or more memory devices are configured to store further instructions thereon that, when executed by the one or more processors, cause the one or more processors to:
generate an updated guidance trajectory based on an adjustment of the one or more operating parameters.

19. A work vehicle comprising,
a frame;
a front tractive assembly coupled to the frame, the front tractive assembly including a front axle;
a rear tractive assembly coupled to the frame, the rear tractive assembly including a rear axle;
a prime mover coupled to the frame and configured to drive one or more of the front tractive assembly and the rear tractive assembly to propel the work vehicle; and
a controller, the controller comprising one or more processors including one or more memory devices coupled to the one or more processors, the one or more memory devices configured to store instructions thereon that, when executed by the one or more processors, cause the one or more processors to:
receive a navigational vector for automatically operating a work vehicle along a guidance trajectory;
receive positional data associated with a positional state of the work vehicle;
estimate a ground position of an approaching divagation condition in the guidance trajectory of the work vehicle based on the positional data; and
adjust one or more operating parameters of the work vehicle prior to arriving at the ground position to compensate for the approaching divagation condition.

20. The work vehicle of claim 19, wherein the one or more memory devices are configured to store further instructions thereon that, when executed by the one or more processors, cause the one or more processors to:
receive a plurality of incoming positional data of the work vehicle over a period of time;
filter the plurality of incoming positional data of the work vehicle over the period of time; and
estimate the positional state of the work vehicle based on the filtered plurality of incoming positional data over the period of time.
